(19) United States
(12) Patent Application Publication
(10) Pub. No.: US 2026/0252477 A1
(43) Pub. Date: Aug. 27, 2026

(54) SOFTWARE TESTING OF A POLICY MANAGEMENT SYSTEM

(71) Applicant: State Farm Mutual Automobile Insurance Company, Bloomington, IL (US)

(72) Inventor: Jacob Carlson, Kenosha, WI (US)

(21) Appl. No.: 19/062,780

(22) Filed: Feb. 25, 2025

(51) Int. Cl. G06F 11/3698; G06F 11/3668

(52) U.S. Cl. CPC G06F 11/3698; G06F 11/368

(57) ABSTRACT

Techniques for implementing regression testing of a software application that interacts with external systems via structured data input/output files are described herein. The systems and techniques described herein allows for verification of differences between a verified and a development version of the software application in a continuous integration (CI) development environment. Additionally, the techniques described herein identify or shortlist code changes that may have caused the differences, and provide a notification to respective developers of the identified code changes. The notifications may indicate the code changes ordered by a likelihood of having caused the differences, and may additionally, provide automatically-generated textual descriptions to aid with the verification.

### TECHNICAL FIELD

The present disclosure relates to software development and deployment. In particular, the present disclosure describes techniques for regression testing of large software applications within a continuous integration environment.

### BACKGROUND

During development of a large software application, multiple developers working independently on the application may integrate their code into a shared source code repository. For instance, developers may make changes to the codebase of the application to implement new features or fix software bugs, and then submit the code changes to a continuous integration (CI) system to be integrated (or merged) within the shared source code repository. To make a change to the existing application codebase, a developer may check-out a portion of the code from the shared repository into a local development environment, where the developer can alter and test their code without affecting other developers. After the updated code builds and executes satisfactorily in the local environment, the developer may check the code back into shared repository. Developers may sync their local environments with the shared repository on a regular basis, so that changes submitted by other developers are incorporated into their local environment. The CI system may perform regular builds on the shared repository to maintain a current version of a development application that includes recent code changes made by the developers to the source code.

The CI system may also periodically promote the development application, and the shared source code repository it is based upon, to a production level. A production application, which performs functions of an enterprise, may be built from the promoted source code e.g., stored in a deployed code repository. However, to assure the continued operation and functionality of the production application, the CI system may only promote the development application to the production level after the development application passes various software testing protocols. During such testing, the CI system may determine whether differences observed in functionality of the development application, when compared with the production application, are as intended by the developers.

The software testing may be based on test scenarios from test suites that may include unit tests designed to test the functionality of relatively small pieces of code, and/or integration tests that test how multiple sub-systems of the application interact. Within a large-scale and robust application, test suites may include thousands or even millions of unit tests and/or integration tests that can be automated and run against an application build. In some instances, the developers may prepare software tests that can be executed to identify bugs in software that should be fixed, to verify that the application operates as expected, and/or to detect other issues with the application. However, in software applications where inputs may be entered via graphical user interfaces (GUIs), and outputs may be received from services external to the software application, it can be difficult for individual developers to determine test inputs and corresponding expected outputs for the test scenarios.

In some examples, the test scenarios may access data from database(s). In such examples, an upgrade to the software application may require changes to the test values of the test scenarios when using the database(s), which may be unchanged. As another example, the database(s) may be updated, and cause an inconsistency with the test values of the test scenarios. For example, a test scenario may exist where a first policy of a new customer (e.g., “John Smith”) is added to the database(s). An update to the database(s) may include the new customer and their first policy e.g., “John Smith” may appear as an existing customer in the updated database(s). Thus, the test scenario may no longer be able to test the addition of a new customer using “John Smith” as an example customer.

In some examples, the software application may interact with other computer-implemented services that may be external to the enterprise that is hosting the software application. In such examples, the software application may not have access to databases, code repositories, and current build of the external services. The interactions may be through transactions in which the software application receives a hierarchical, structured data file (e.g., a JSON file) in response to an input data file provided to the external services.

In the scenarios discussed above, it can be difficult, time-consuming, and/or resource-intensive to implement software testing protocols that can identify changes to overall system behavior, and determine which changes require verification by the developers e.g., some changes may not be significant and simply be incidental.

The example systems and methods described herein may be directed toward mitigating or overcoming one or more of the deficiencies described above.

### SUMMARY

To address these and other problems and inefficiencies, this disclosure describes systems and techniques for implementing regression testing of a software application that interacts with external systems via structured data input/output files. The systems and techniques described herein enable verification of differences between a development version of the software application in a continuous integration (CI) development environment and a production, or other stable version of the software application. The systems and techniques described herein may also determine likelihoods that respective code changes checked into a shared repository may have been the cause of observed differences in outputs of the application, and provide developers with tools for verifying that the differences are as intended.

According to a first aspect, a software testing system is configured to receive first input data including entries in a graphical user interface (GUI), provide, to a first software application, at least a portion of the first input data, and receive, from the first software application and based on the first input data, first output data characterized by a structured hierarchy indicating data fields. The system is further configured to provide, to a second software application, the at least the portion of the first input data, and receive, from the second software application and based on the at least the portion of the first input data, second output data characterized by the structured hierarchy. The system is yet further configured to remove from the first output data and the second output data, data values corresponding to at least a portion of the data fields of the structured hierarchy, wherein removing the data values results in filtered first output data and filtered second output data, determine a difference between the filtered first output data and the filtered second output data, determine, based on the difference, one or more changes in source code between the first software application and the second software application, and provide, to an electronic device, a notification indicating the difference and the one or more changes.

According to a second aspect, a computer-implemented method includes receiving a first input data indicating inputs to a software application, providing, to a development version of the software application, the first input data, and receiving, from the development version of the software application and based on the first input data, a first output data characterized by a structure comprising named data fields and corresponding data values. The computer-implemented method further includes providing, to a verified version of the software application, the first input data and receiving, from the verified version of the software application and based on the first input data, a second output data characterized by the structure. The computer-implemented method yet further includes removing, from the first output data and the second output data, data values corresponding to at least a portion of the named data fields of the structure, wherein removing the data values results in filtered first output data and filtered second output data, determining a difference in the named data fields or the corresponding data values between the filtered first output data and the filtered second output data, determining, based on the difference, one or more changes in source code between the development version of the software application and the verified version of the software application, and providing, to an electronic device, a notification indicating the difference and the one or more changes.

According to a third aspect, one or more non-transitory computer-readable media store computer-executable instructions, the computer-executable instructions, when executed by one or more processors, cause the one or more processors to: receive a first input data indicating test inputs to a software application, provide, to a first version of the software application, the first input data, receive, from the first version of the software application and based on the first input data, a first output data characterized by a structure comprising data fields and corresponding data values, provide, to a second version of the software application, the first input data, receive, from the second version of the second software application and based on the first input data, a second output data characterized by the structure, remove, from the first output data and the second output data, data values corresponding to at least a portion of the data fields of the structure, wherein removing the data values results in filtered first output data and filtered second output data, determine a difference in the data fields or the corresponding data value between the filtered first output data and the filtered second output data,, determine, based on the difference, one or more changes in source code between the first version of the software application and the second version of the software application, and provide, to an electronic device, a notification indicating the difference and the one or more changes.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a computing environment implementing a continuous integration (CI) system for a software application and providing regression testing of a development version of the application against a previously verified version of the application.

FIG. 2 illustrates examples of comparisons between outputs of the development version of the software application and the verified version of the software application.

FIG. 3 shows a flowchart illustrating an example method for performing a regression test that determines whether a software application passes or fails the test.

FIG. 4 illustrates an example graphical user interface for providing information to and receiving feedback from a developer of the software application related to the regression test.

FIG. 5 shows an example architecture for a computing system that can execute one or more elements associated with the computing environment implementing the regression testing functionality.

### DETAILED DESCRIPTION

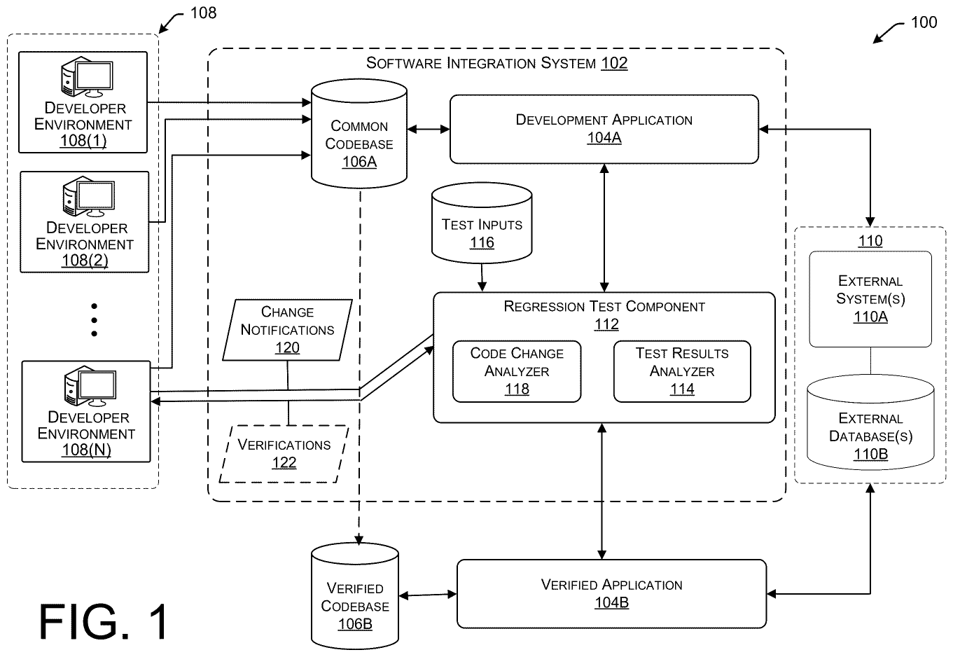

FIG. 1 shows an example of a computing environment 100 configured to perform regression testing for an application. The computing environment 100 may include a software integration system 102 associated with an application, which may maintain a development application 104A, and a common codebase 106A from which the development application 104A is built. In examples, the software integration system 102 may maintain the common codebase 106A containing application source code of the development application 104A, within a shared source code repository accessible to developers 108 via respective local developer environment(s) 108(1, . . . , N).

For example, the software integration system 102 may manage requests from the local developer environment(s) 108(1, . . . , N) to check-out portions of the application source code from the common codebase 106A, which may be copied from the common codebase 106A to the local development environment(s) 108(1, . . . , N). After the checked-out source code is modified by a developer in the respective local developer environment 108(1, . . . , N), the software integration system 102 may receive a request from the developer to check-in (or integrate) the modified code back into the common codebase 106A. The request may also include a summary of changes made, features added, problems addressed, etc. To integrate the modified code, the software integration system 102 may receive or upload the modified code from the local developer environment 108(1, . . . , N), and perform the necessary code replacements or overwrites to merge the modified code from the developer into the common codebase 106A. In some examples, hundreds of developers 108 (e.g., N>100) may be making changes to the common codebase 106A simultaneously.

The software integration system 102 may keep track, in association with the source code in the common codebase 106A, a history of code changes that are checked-in by the developers 108. The history of code changes may indicate an identification of the developer environment 108(1, . . . , N) from which each code change was checked in, a timestamp indicating a date and time of the check-in, annotations (e.g., code comments, track changes, etc.), other metadata identifying the specific changed portions of the code that are different from the corresponding code within the common codebase 106A, and/or comments explaining a reason for the code changes (e.g., identifying a bug that was fixed, feature that was added, efficiency improvement, etc.). In some examples, the software integration system 102 may perform automated compiling, building, and/or testing as part of a code integration process, in order to verify that the incoming code changes from the developer environments 108(1, . . . , N) do not break the build or introduce software bugs into the development application 104A.

In examples, the software integration system 102 may periodically promote the application source code in the common codebase 106A to a verified codebase 106B, from which a verified application 104B, which may be a production application, is built. In some examples, promoting the common codebase 106A to the verified codebase 106B may comprise tagging a snapshot (e.g., a particular version or code state at a particular time) of the common codebase 106A as the verified codebase 106B. The verified application 104B may then be built from the snapshot of the common codebase 106A that is tagged as the verified codebase 106B. In other examples, the verified codebase 106B may be a replication of the common codebase 106A that is promoted as verified.

In some examples, the software integration system 102 may replace or update the verified codebase 106B based on a regular schedule (e.g., daily, weekly, every quarter, etc.), or based on a software feature release calendar associated with verified application 104B, and trigger a rebuild of the verified application 104B based on the updated verified codebase 106B. In some examples, the verified application 104B may be a production version of the software application, which may be the version of the application deployed by the enterprise to perform its functions.

In examples, the application corresponding to the development application 104A and the verified application 104B may be a large, complex application that performs various functions of an enterprise, and includes graphical user interfaces (GUIs), transactions with customers and agents of the enterprise, internal and/or external database access, interactions with cloud-based systems, interactions with external software services, etc.

In some examples, the development application 104A and the verified application 104B may communicate with computing system(s) 110 external to the enterprise. For example, external system(s) 110A hosted on the computing system(s) 110 may provide software services from vendors external to the enterprise. In such examples, the software integration system 102 may not have access to source code corresponding to external system(s) 110A and/or have no access to the external databases(s) 110B. Instead, the development application 104A and the verified application 104B may communicate with the external system(s) 110A via structured request(s), and may receive corresponding structured response(s) from the external system(s) 110A. In some examples, the application 104A, 104B may accept inputs as user entries via a graphical user interface (GUI), and may not support inputs provided in a file.

As an example, the application 104A, 104B may be a policy management system that is used by an insurance company to manage policy data associated with insurance policies. For example, an insurance company can use a computer-implemented policy management system to store information about insurance policies, create new insurance policies, change existing insurance policies, and/or otherwise manage insurance policies. Such insurance policies can include automobile insurance policies, home insurance policies, fire insurance policies, and/or other types of insurance products. The insurance company may interact with external computer-implemented services (such as the external system(s) 110A) to perform some tasks related to policy management, such as billing services, payment services, policy renewal services, rating services, client services, call center services or other customer support services, and/or other types of services.

In such examples, the external computer-implemented services may store policy data indicating information about corresponding insurance policies, insurance risk tables, underwriting tables, premium rate tables, etc., in the external database(s) 110B. For example, policy data for an automobile insurance policy can include one or more of: a client identifier, a policy number, an agreement number, an insurance company identifier, an insurance agent identifier, an address, a vehicle identifier, mandatory coverage information, vehicle use information, a guaranteed renewal status, a term, a term length, renewal dates, driver exclusions, billing methods, billing accounts, and/or other types of information. Policy data for other types of insurance policies may include similar types of information relevant to the other types of insurance policies.

The software integration system 102 may need to ensure that the verified application 104B continues to function correctly (e.g., maintaining its verified status) when code changes to the common codebase 106A are promoted to the verified codebase 106B. For example, in examples where the verified application 104B corresponds to the production version of the software application that performs the functions of the enterprise, the software integration system 102 may need to ensure that functioning of the verified application 104B is not negatively impacted by the release of code changes from the common codebase 106A to the verified codebase 106B. In examples of the present disclosure, the software integration system 102 may implement a regression test component 112 to determine differences between outputs of the verified application 104B and the development application 104A, and may further analyze the differences to determine whether the promotion of the application source code in the common codebase 106A to the verified codebase 106B would result in overall changes to the verified application 104B that are as intended by the developers 108. The regression test component 112 may return a result of “pass” if any differences in functionality of the verified application 104B caused by code changes are as intended by the developers, and may return a result of “fail” if unintended differences or software bugs are determined during the regression testing. The software integration system 102 may control the promotion of code from the common codebase 106A to the verified codebase 106B based on the result of the regression testing, as described below.

During development of the application, developers 108 may also prepare test cases to verify that the application operates as expected. Such test cases may include unit tests designed to test the functionality of relatively small pieces of code, and/or integration tests that test how multiple pieces of code interact. Because individual test cases may be designed to test one or more relatively small aspects of the overall software application, for a large-scale application such as the applications 104A, 104B, described above, testing based on developer-provided unit tests, that test for validity of small portions of the source code, may be insufficient. For example, such unit tests may not be able to specify “correct” output data due to lack of access to the external database(s) 110B, and may only be able to indicate success or failure based on completing a transaction (e.g., a request and a response) with the external system(s) 110A. In addition to unit tests, software testing may also use acceptance tests that can test for overall outcomes. Such tests may be able to verify successful navigation through various screens of a GUI associated with the application (e.g., by checking that the navigation ends in a “success” screen at an end of a task), but not provide sufficient granularity to be able to indicate whether results (e.g., premiums, coverage codes, claim amounts approved, etc.) displayed are accurate.

As discussed above, the verified application 104B is built from the verified codebase 106B, which may be a tagged version of the common codebase 106A indicating that the version is promoted to a verified status. In examples, promoting the common codebase 106A to the verified codebase 106B is equivalent to promoting the development application 104A to be the verified application 104B. In examples, a test results analyzer component 114 of the regression test component 112 may compare outputs received from the development application 104A and the verified application 104B in response to an input from test inputs 116. In some examples, the input may include data that is core data for a test scenario being tested by the input, as well as data that is incidental data (e.g., not relevant to detecting differences in output(s) of the software application). For example, in a test scenario testing a transaction, core data may include client attributes that affect the transaction, and incidental data may include other client data that are not relevant to the transaction. In examples, the regression test component 112 may provide a first input to the development application 104A comprising at least the core data of the test scenario of an input of the test inputs 116, and the first input to the verified application 104B. For example, the first input to both the development application 104A and the verified application 104B may correspond to a test scenario determining insurance premiums for a client, and comprise the same core data including the same birthdate, address, driving history, and the like. However, other incidental data that the regression test component 112 provides to the applications 104A, 104B may differ.

The development application 104A may process the first input, and interact with the external system(s) 110A to determine a first output based on the first input. The verified application 104B may also process the first input, and interact with the external system(s) 110A to determine a second output based on the first input. The test results analyzer 114 may then process the first output and the second output to determine one or more differences. In examples, the regression test component 112 may provide the first input to the development application 104A and the verified application 104B in any temporal order. For example, the verified application 104B may process the first input prior to (e.g., hours, days or weeks earlier than) the development application 104A processing the first input. In some examples, the outputs of the verified application 104B in response to one or more inputs of the test inputs 116 may be generated and stored before the regression test component 112 provides the one or more inputs to the development application 104A.

The test inputs 116 may store individual test cases indicating input data, which may have been entered via the GUI associated with the application, and other data designed to test one or more functionalities of the application. For example, the test inputs 116 may include entries in each field of a GUI screen for a set of GUI screens that end in a completion of a task that the application may be used to perform. For example, entries may include a client's birthdate, address, vehicle information, prior claims, etc. In some examples, the entries may also include selection of radio buttons, dropdown menu items, and other GUI elements. In examples, some fields may be hard-coded with values, while other fields may be computed during processing. The input data may also include user attributes such as a role of the user (e.g., underwriter, agent, customer, etc.). In some examples, a test case may include a history indicating pre-existing ratings, prior transactions, and the like. Non-limiting examples of such tasks may include determining insurance quotes, entering a claim, updating customer information, adding a new auto or home insurance policy to a customer, determining customer discounts, and the like. The test inputs 116 may be designed by an application development or testing team, may be real-world test inputs gathered from actual usage of the verified application 104B, may include edge cases or previous test inputs that were considered to be challenging or produced errors in the application, and/or unit tests for checking specific portions of the source code or the GUI functionality.

In examples of the application, the first output and the second output may comprise hierarchical, structured files. As an example, the first output and the second output may comprise files in JSON format. As another example, the first output and the second output may comprise files in extensible markup language (XML) format. In such files, individual data field values are associated with a data field name, and the files may comprise hierarchical (e.g., nested) groupings of such data field name-value pairs. As another example of such files, the individual data field values in the file may be associated with identifiers indicating keys or fields in a database schema.

As discussed, the test results analyzer 114 may process the first output and the second output to determine one or more differences. However, in examples of the present disclosure, a simple file differencing may not provide an accurate indication of differences that are significant (e.g., indicative of differences in function between the development application 104A and the verified application 104B), and may include differences that are irrelevant or incidental. In examples, the test results analyzer 114 may filter out one or more data fields based on the field name or identifier that are known to be irrelevant. As an example, it may be known that each request to the external system(s) 110A is assigned a unique identification number which is stored in a field named “session ID.” The test results analyzer 114 may ignore differences in the “session ID” field, since the request from the development application 104A and the verified application 104B would have difference values in the “session ID” field, irrespective of whether there are any differences between the development application 104A and the verified application 104B. As another example, the test results analyzer 114 may filter out a date/time of the request, which may be associated with a “date/time” field, as this data is based on a timing of the requests, and not indicative of a difference in functionality between the development application 104A and the verified application 104B.

Further, the test results analyzer 114 may ignore differences in ordering of name-value pairs within a grouping of data associated with one or more field names, where it is known that the ordering is incidental for the one or more field names. For example, an underwriting quote may be based on M different, and independent, evaluations, and a grouping of data associated with a field name of “evaluation results” may hold results of the M evaluations. The ordering of the M evaluations within the grouping may simply be based on an order in which the evaluations were completed by the external system(s) 110A, and may be immaterial to a value of the underwriting quote determined based on the evaluations. In this example, the test results analyzer 114 may determine that each of the M evaluations are included in the grouping of data associated with “evaluation results,” but ignore an order in which the evaluations occur in the first output and the second output. As another example, a data array associated with a particular field name (e.g., a “driver rating” field that includes various factors affecting such a rating) may contain data where the ordering is known to be irrelevant, and the test results analyzer 114 may determine, based on identifying the particular field name, that there are no differences if the data array in the first output a permutation of the corresponding data array of the second output.

In some examples, the test results analyzer 114 may also flag differences in data types associated with variables in the first output and the second output. For example, the test results analyzer 114 may determine a difference between the first output and the second output if a first value in the first output is of a first type (e.g., an integer) and a second value in the second output corresponding to a same field name is of a second type (e.g., a float) different from the first type, even if a difference between the first value and the second value evaluates to zero. As another example, the test results analyzer 114 may determine a difference between the first output and the second output if a third value of the first output is an empty character (e.g., “”), whereas a corresponding fourth value of the second output is specified as a null character (e.g., NULL). It is understood that differences in data types may lead to significant differences in system output in some instances, even if an error is not apparent based on a particular instance of the test inputs 116.

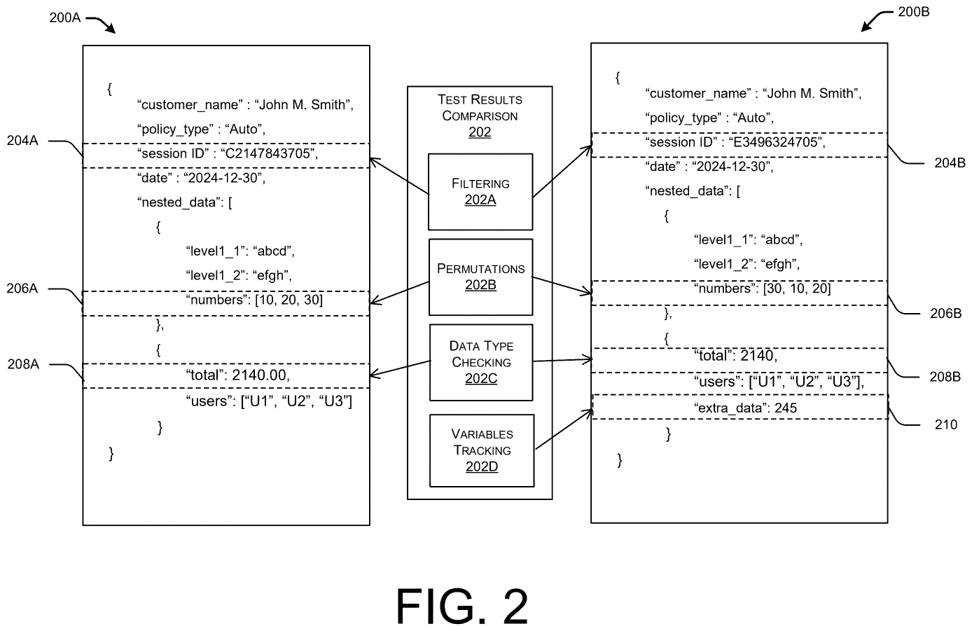

In some examples, the test results analyzer 114 may determine a difference between the first output and the second output based on addition or removal of data fields or variables in the files. For example, the first output may include an additional field name that is not present in the second output. As discussed above, the test results analyzer 114 may be customized to exhibit different behaviors based on knowledge of contents of various data fields, and their relevance to detecting actual differences in functionality of the application. An example of determination of differences between the first output and the second output is described in further detail with reference to FIG. 2.

Additionally, the applications 104A, 104B may generate an event feed during operations that accumulates all attributes related to a current state of processing during a session. For example, for a claims processing session, the attributes may include a number of vehicles, drivers, legal contracts, coverage data, keys to database tables with rates, and the like. In some examples, an event may include thousands of attributes. In some examples, the test results analyzer 114 may determine differences between a first event feed generated by the verified application 104B and a second event feed generated by the development application 104A. The test results analyzer 114 may ignore specific texts and/or changes in data that are known to be incidental.

In some examples, the event feed may provide a snapshot of data and transactions related to a policy. In some examples, the event feed may only include data related to a particular type of event being processed. For example, adding a new driver to an automobile insurance policy may result in an event feed that comprises a snapshot of the entire policy including all drivers and vehicles covered, or in some examples, the event feed may include only data related to the new driver. Such event feeds may be compared to determine differences as discussed with reference to the outputs of the applications.

The regression test component 112 may also implement a code change analyzer 118 that determines one or more code changes that are relevant to the difference(s) determined by the test results analyzer 114. As discussed above, the software integration system 102 maintains a history of code changes associated with the common codebase 106A, including timestamps associated with each code change. In examples, the code change analyzer 118 may determine, based on the timestamps associated with the code changes, a set of code changes that were checked-in during a time period between a first date/time on which the verified codebase 106B (on which the verified application 104B was built) was last updated, and a second date/time on which the development application 104A was built. This set of code changes are expected to include any code changes responsible for the difference(s) determined by the test results analyzer 114. In another example, the code change analyzer 118 may determine the set of code changes as code changes that were checked-in to the common codebase 106A after a most recent, previous successful regression test.

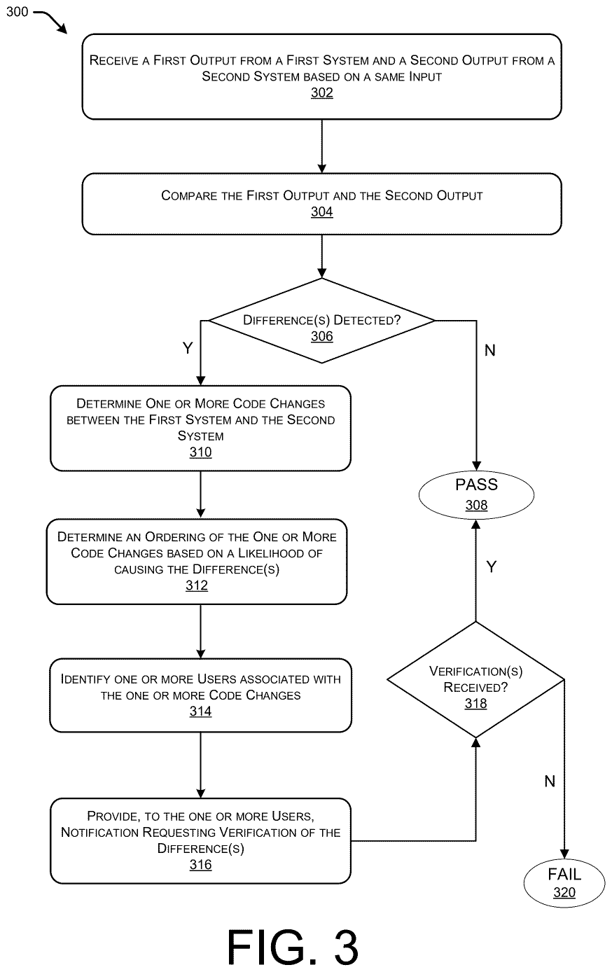

In some examples, the code change analyzer 118 may determine, for individual code change of the set of code changes, a likelihood or certainty level that the code change may have caused one or more of the difference(s) determined by the test results analyzer 114. In such examples, the code change analyzer 118 may order the set of code changes in decreasing order of likelihood, or determine a subset of the set of code changes that have a likelihood greater than a threshold likelihood. In some examples, the code change analyzer 118 may determine the likelihood by inputting the code change and/or annotations and comments associated with the code change, to an artificial intelligence (AI) system, such as a large language model (LLM), trained to associate differences in output with underlying code changes, as described in further detail with reference to FIG. 3. Alternatively, or additionally, the code change analyzer 118 may use a look-up table or a rule-based system to associate code changes with observed difference(s). In some examples, the code change analyzer 118 may use LLMs to further generate summaries of the code changes, the difference(s), and/or business impact of the difference(s).

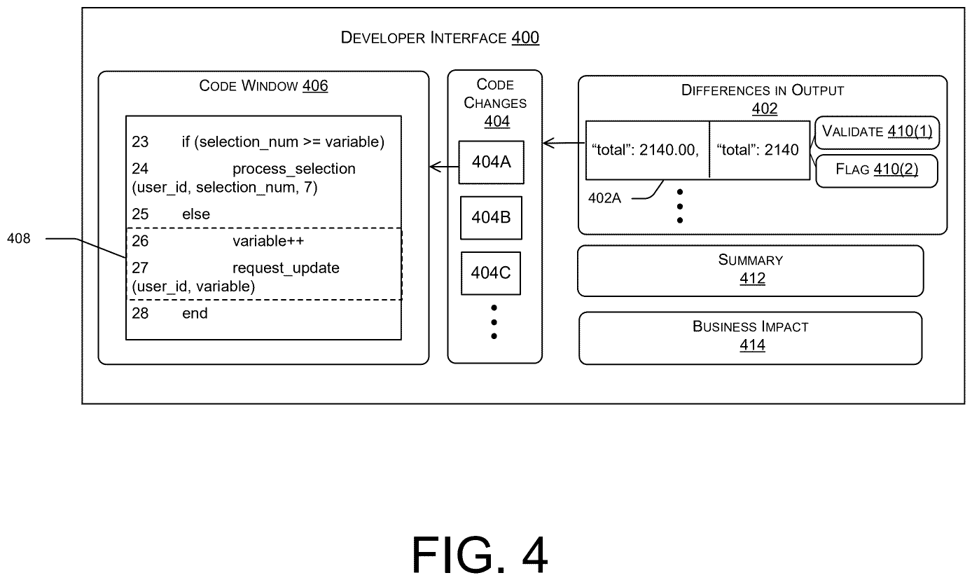

Based on the set of code changes (or a subset thereof) determined by the code change analyzer 118, the regression test component 112 may provide, to developers associated with the set of code changes, via their respective developer environment(s) 108 (1, . . . , N), change notifications 120 for verification. The change notifications 120 may identify the code changes from the set of code changes that are attributed to the respective developer, the difference(s) determined by the test results analyzer 114, and/or the test input(s) that were used when the difference(s) were determined. The change notifications 120 may be provided via a GUI in the developer environment 108, as described in further detail with reference to FIG. 4. In some examples, additional information such as a textual summary of changes, textual summary of differences, and/or business impact of the differences may also be included in the change notifications 120. In some examples, the additional information may be based on annotations and/or comments provided with the code changes inline (i.e., as part of the code) or during the code change check-in. Additionally, or alternatively, the additional information may be provided by the code change analyzer 118 using output text of LLMs, as discussed above.

In response to the change notifications 120, the respective developer(s) 108 receiving such notifications, may provide, via the GUI in the developer environment 108, verifications 122. The verifications 122 may indicate that one or more of the difference(s) noted in the change notifications 120 are as expected by the respective developer(s). If the regression test component 112 receives a verification, in the verifications 122, corresponding to each change notification of the change notifications 120, then the regression test component 112 may return a result of “pass” for the regression test. In response to the determination of a result of “pass,” the software integration system 102 may allow the verified codebase 106B to be updated to or synced with the common codebase 106A and/or trigger a rebuild of the verified application 104B based on the updates or synced verified codebase 106B.

However, if the regression test component 112 does not receive verifications 122 corresponding to one or more of the change notifications 120, the regression test component 112 may return a “fail” result for the regression test, as described in further detail with reference to FIG. 3. The software integration system 102 may cancel an update or sync of the verified codebase 106B and prevent a rebuild of the verified application 104B in response to the “fail” result, thus protecting continued operation of the enterprise based on the verified application 104B that was already in place. For example, one or more developers may determine that there is a software bug or the change notifications 120 identify unexpected difference(s), and accordingly, may withhold providing the verifications 122. There may be further coding activity to fix the software bugs and/or determine the causes of the unexpected difference(s), followed by code change check-ins to the common codebase 106A to address these issues. The regression test component 112 may run the regression test periodically, and may determine a “pass” result once the development application 104A is rebuilt based on the common codebase 106A which includes the fixes.

As these examples illustrate, the techniques described herein provide technical advantages and improvements in software development and testing that include a continuous integration system associated with a large, complex application that is critical to maintaining business functions of an enterprise. In particular, the software integration system 102 may be configured to execute regression testing to ensure that a production version of the application is not inadvertently impacted by code changes made by developers. As discussed, various protocols generally used in software integration may be difficult or time-consuming to apply to the environment described herein. For example, requiring developers to provide unit tests that include inputs and expected outputs may not be feasible for an application that interacts with external systems where the application has no access to source code or databases used by the external systems. Instead, the software integration system 102 uses the production version of the application to provide target outputs to test inputs.

Additionally, the regression test component 112 described herein can handle hierarchical, structured outputs where simple differencing operations may not indicate actual changes in functionality of the application. The software integration system 102 also includes a notification system supported by artificial intelligence techniques that allow for efficient verification of differences detected, without overwhelming developers with irrelevant code verification tasks. As a result, the regression testing may be performed more quickly and using fewer computing resources, allowing the testing to be performed more efficiently and flexibly during the software development process. The software integration system 102 may also complete pre-release regression testing more efficiently in response to code changes submitted by developers, allowing the software build, test, and development teams to more quickly detect software bugs and/or inadvertent changes in functionality of the application, without impacting the production version of the application, which is critical to the functioning of the enterprise.

FIG. 2 illustrates an example comparison between structured outputs of a development version and a production version of an application. As shown in FIG. 2, a first output 200A of a development version of the application, such as the development version 104A, and a second output 200B of a production version of the application, such as the verified version 104B, may be compared by a test results comparison component 202 to determine whether there are any differences that may be significant. The test results comparison component 202 may be a part of the test results analyzer 114 shown in FIG. 1.

As discussed with reference to FIG. 1, the first output 200A and the second output 200B may comprise structured data files which may also be hierarchical. In the example shown in FIG. 2, the first output 200A and the second output 200B are shown in a format similar to a JSON file, and includes hierarchical data in name-value pairs (e.g., “customer_name”: “John M. Smith”; “total”: 2140, etc.). The test results comparison component 202 may implement various sub-components for identifying differences between the outputs 200A and 200B that are indicative of differences in functionality between the development and production versions of the application.

In some examples, the test results comparison component 202 may implement a filtering component 202A that identifies data to be ignored by the test results comparison component 202. The filtering component 202A may filter out differences between the outputs 200A and 200B which are not significant e.g., are not indicative of differences in functionality between the development and production versions of the application. In some examples, the filtering component 202A may access a lookup table indicating field names associated with incidental or transient data, and filter out such data fields. In the example shown in FIG. 2, the name-value pairs 204A and 204B may be associated with a field name “session ID” which is set to a new value for each interaction. As such, the data associated with the field name “session ID” is expected to be different, and does not indicate differences in functionality between the applications that produced the outputs 200A and 200B. Accordingly, the “session ID” field name may be included in the lookup table of field names to be ignored, and the filtering component 202A may remove or flag to ignore data corresponding to the name-value pairs 204A and 204B. Other examples of such data may include data based on a date/time the application is run, a temporary user ID assigned to a guest user, data identifying a server or IP address associated with execution, and the like.

In some examples, the test results comparison component 202 may implement a permutations component 202B that may determine whether two arrays, such as “numbers” 206A, 206B shown, differ merely in an arrangement of their elements, while containing the same values of the elements. In some examples, an ordering of elements of an array or other groupings of data may not indicate changes in functionality of the application if the ordering is incidental and varies from run to run. For example, the elements in the array may be inserted based on an order in which results were received from processes, and thus, may be different each time the application is run. In such examples, the permutations component 202B may determine that there is no difference if the same elements are ordered differently e.g., the ordering is a permutation of each other.

In some examples, the test results comparison component 202 may implement a data type checker 202C. A data type (e.g., integer, float, double, alphanumeric, string, etc.) is a significant characteristic of data, and any changes in the data type may indicate a significant difference in functionality of the application. The data type checker 202C may compare the data types in the outputs 200A and 200B to identify differences in the data types of the data. In the example shown, data 208A associated with a field name “total” is of data type float, whereas data 208B associated with the same field name is of data type integer. Based on this difference in data types, the data type checker 202C may add the difference between data 208A an 208B as a significant difference between the outputs 200A and 200B.

In some examples, the test results comparison component 202 may further implement a variables tracker 202D that may keep track of variables (e.g., field names) appearing in the outputs 200A and 200B. The variables tracker 202D may identify missing variables in the output 200B or additional variables in the output 200B when compared with the output 200A. In the example shown, an extra variable 210 (with field name “extra_data”) appears in the output 200B, that is not present in the output 200A. The variables tracker 202D may add any such differences in the presence of variables as a significant difference between the outputs 200A and 200B.

It is to be noted that though some examples of customizing the test results comparison component 202 with specific sub-components are shown in FIG. 2, the test results comparison component 202 may include other filters to ignore differences between data or checkers to determine specific aspects of data that are different between the outputs 200A and 200B. The differences that are ignored and/or the differences that are deemed significant by the test results comparison component 202 may be based on knowledge about the field names generated by the application.

FIG. 3 shows a flowchart illustrating an example process 300 for performing a software test that determines whether a software application passes or fails the test. As discussed, the software test may be a regression test to identify differences in output between a production version of an application and a development version of the application in response to identical inputs. The process 300 can be performed by the software integration system 102, or the regression test component 112, as discussed below. The order in which the operations are described should not be construed as a limitation. Any number of the described operations can be combined in any order and/or in parallel to implement the process 300, and not all of the operations need be executed.

At operation 302, the regression test component 112 may receive a first output from a first system and a second output from a second system based on a same input. As discussed with reference to FIG. 1, the first system may be the verified application 104B built from the verified codebase 106B, and the second system may be the development application 104A which is being compared with the verified application 104B during a regression test. In examples, the first output may be used as a baseline, and the regression test component 112 may aim to identify differences between the verified application 104B and the development application 104A.

As also discussed, the first output and the second output may each comprise structured data files including hierarchical (e.g., nested) data elements. As an example, such a structured data file may be in a JSON format, with data values associated with corresponding field names. In some examples, the data values may be associated with database keys corresponding to a database schema.

At operation 304, the regression test component 112 may compare the first output and the second output. In particular, the test results comparison component 202, as described with reference to FIG. 2, may perform the comparisons between the first output and the second output at the operation 304. For example, the comparison of the first output and the second output at the operation 304 may incorporate knowledge regarding fields in the outputs. For example, it may be known that values in a given field are expected to be different irrespective of whether there are actual differences between the first system and the second system e.g., they may be based on a date/time, IP address, temporary variable value, etc. In such an example, the test results comparison component 202 may ignore differences in the values of such fields. In some examples, an ordering of elements within arrays or groupings of data in some fields may be irrelevant, and the comparison may ignore such differences in ordering. In other instances, a data type of a field may be significant, and a difference may be determined if the data types in the first output differ from the corresponding data types in the second output. As a result of the comparison at the operation 304, the test results comparison component 202 may determine one or more differences between the first output and the second output.

At operation 306, the test results analyzer component 114 may determine whether one or more difference(s) are detected between the first output and the second output, based on the comparisons between the first output and the second output at the operation 304. If one or more difference(s) are not detected based on the comparison at the operation 304 (“N” at operation 306), the test results analyzer component 114 may determine that the regression test between the first system and the second system based on the same input results in a “PASS” 308. A result of “PASS” 308 indicates that the first output and the second output have no significant differences (but may still differ in data that is considered irrelevant and filtered out). It is to be noted that the process 300 may be repeated for a large number (e.g., thousands, or even hundreds of thousands) of pairs of first and second outputs, each based on a different same input provided to the first system and the second system. The test results analyzer component 114 may output a result for each pair of inputs, and all pairs of inputs may not result in a determination of “PASS.”

If one or more difference(s) are detected based on the comparison at the operation 304 (“Y” at operation 306), the code change analyzer 118 may, at operation 310, determine one or more code changes between the first system and the second system that may be relevant to the one or more difference(s) detected. In some examples, the code change analyzer 118 may determine the one or more code changes based on timestamps associated with the first system and the second system. For example, the code change analyzer 118 may identify the one or more code changes as a set of code changes that were checked-in to a common codebase from which the second system is built with a check-in timestamp that falls after a previous “PASS” result.

At operation 312, the code change analyzer 118 may determine an ordering of the one or more code changes based on a likelihood of causing the difference(s) detected. In some examples, the code change analyzer 118 may determine the likelihood corresponding to each code change of the one or more code changes by inputting the code change and/or annotations and comments associated with the code change, to a machine-learned (ML) model trained to associate differences in output with underlying code changes. Such an ML model may be trained on training data that includes changed code segments and resulting differences in the output of the application built from a codebase that includes the changed code segments. Alternatively, or additionally, the code change analyzer 118 may use a look-up table or a rule-based system to associate code changes, and/or annotations or comments associated with the code changes, with the detected difference(s).

In some examples, the likelihood corresponding to a code change may be determined using generative artificial intelligence (AI) models (e.g., large-language models). As an example, a first code change of the one or more code changes may be provided as input to a first generative AI model to receive, as output, a summarization of the first code change. In some examples, the operations may be repeated for each code change, generating a summarization for each code change of the one or more code changes. The summarization, the difference(s), and additional metadata (e.g., definitions, allowed values, and data relationships, etc.) related to the outputs may be provided as input to a second generative AI model. Additionally, the inputs to the second generative AI model may include results of previous regression tests, including defects detected along with respective mapping to source code and/or developer defect history. The second generative AI model may be provided prompts to generate, as output, a likelihood of the difference(s) being due to the first code change based on the summarization and other inputs provided to the second generative AI model. In some examples, the second generative AI model may be configured to output a limited number of options e.g., “very likely” or “not likely at all” may be the only two options. In other examples, the number of options may be larger e.g., 5, 10, or 100. The operations described may be repeated for each of the one or more code changes. In some examples, the operations may be repeated for each code change, while providing each difference of the difference(s) separately to the second generative AI model, to determine a likelihood that the respective code change caused the respective difference.

In some examples, the one or more code changes may be ranked based on decreasing likelihood, or a threshold likelihood may be used to determine a subset of the one or more changes (e.g., code changes with a likelihood less than the threshold likelihood may be filtered out). In some examples, the one or more code changes may be ranked using various additional factors, such as metadata associated with the difference(s), the code change, and/or the developer, in addition to the likelihoods generated. For example, the metadata may be used to determine a score for a code change on a 100-point system. The ranking method used by the code change analyzer 118 may be configurable.

At operation 314, the code change analyzer 118 may identify one or more users associated with the one or more code changes. The users may be developers who have checked in the one or more code changes into a shared codebase from which the second system is built. A history of code change check-ins, as is typically maintained by a version control system, may identify the user responsible for each code change that is checked-in. The code change analyzer 118 may access the history of check-ins to identify the one or more users associated with the one or more code changes.

At operation 316, the regression test component 112 may provide, to the one or more users, notification requesting verification of the difference(s). In examples, the users may receive the notifications in their development environments via a GUI. For example, the notification may appear in their workspace when they login to the development environment. In some examples, the notifications may also be provided to a user via email or text, or as comments in the developer codebase of the user. The notifications may identify the code changes that are checked-in by the respective user, the difference(s) detected, and the input to the second system. In some examples, the notification may include additional information such as a textual summary of changes, textual summary of differences, and/or business impact of the differences. In some examples, the additional information may be based on annotations and/or comments provided with the code changes inline (i.e., as part of the code) or during the code change check-in and/or output text generated by LLMs based on an input of code segments corresponding to the code change. The notifications may be associated with a verification tool that a user can use to indicate that the difference(s) detected were as intended.

At operation 318, the regression test component 112 may determine whether verification(s) have been received for each of the difference(s) detected. If the verification(s) have been received (at operation 318, “Y”), then the regression test component 112 may determine that the result of the regression test is “PASS” 308. The process 300 may then repeat for a next pair of first and second outputs that are based on a different input provided to the first and second systems. In the verification(s) have not been received (at operation 318, “N”), or a positive confirmation is received that the difference(s) detected are not as expected by the user(s), then the regression test component 112 may assign a result of “FAIL” 320 to the regression test.

FIG. 4 illustrates an example graphical user interface providing information related to a software test, such as a regression test, to a developer of the application. The developer may receive a notification, such as the change notifications 120, generated by the software integration system 102 in response to results of regression testing by the regression test component 112. As discussed with reference to FIG. 1, the change notifications 120 may include differences in output of a verified application 104B with a development application 104A, identification of code changes that may be relevant to causing the differences, and/or additional information. The developer may receive the change notifications 120 via a developer interface 400 displayed in the developer's environment 108 (1, . . . , N).

In some examples, the developer interface 400 may provide a listing of differences in output 402 of the verified application 104B as compared with the development application 104A in response to same test inputs 116. Selecting a difference (e.g., 402A shown) from the listing of differences 402 may provide a listing of code changes 404 that may be relevant to the difference 402A. In some examples, the code changes 404A, 404B, 404C, etc. may be listed in decreasing order of likelihood of having caused the selected difference, to make it more efficient for the developer to identify a cause of the difference. As discussed, the code changes 404 and corresponding likelihoods may be determined by the code change analyzer 118. In such examples, the ordering and items listed in the changes 404 may change based on the difference selected from the differences listing 402.

In some examples, the code changes 404 may be identified by a date/time of check-in, annotations or comments associated with the check-in, and/or files that were changed. In some examples, the code changes 404 may include changes checked in by a particular developer (e.g., based on the developer environment 108 that the developer interface 400 is displayed in). In other examples, the code changes 404 may include all changes relevant to the difference selected, and the interface 400 may allow the developer to select code changes by developer. The developer may select a code change (e.g., 404A shown) to open and view source code files in a code window 406. In some examples, the changes 408 in the source code may be highlighted or otherwise indicated.

The developer interface 400 may provide a validate option 410(1) and a flag option 410(2) (e.g., as selectable buttons or widgets) along with each difference of the differences 402, enabling the developer to provide feedback regarding the difference. For example, the developer may select the validate option 410(1) to indicate that the corresponding difference is as they expected or intended, and the developer may select the flag option 410(2) to indicate that the corresponding difference is unintended or incorrect (resulting in a “fail” determination for the regression test). The code changes 404 and the code window 406 may provide the developer with tools to review and verify relevant source code in order to make a determine whether the difference 402A is valid. Additionally, the developer interface 400 may include a summary 412 of the differences in output 402 and/or a business impact 414 of the differences 402. In some examples, these fields may be automatically generated using generative AI models.

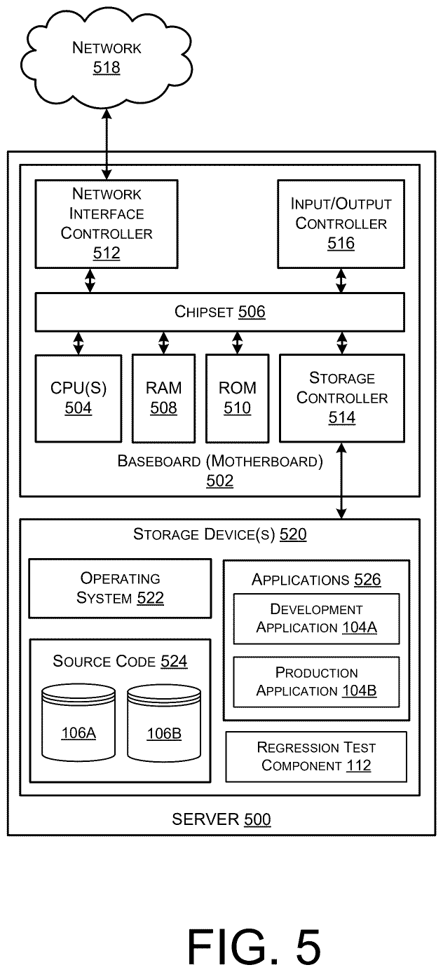

FIG. 5 shows an example architecture of a computer server 500 capable of executing program components for implementing the various functionality described herein. Although the computer architecture in this example is labeled as a server, it can be understood from this disclosure that similar or identical computer architectures may be implemented via workstations, desktop or laptop computers, tablet computers, network appliances, mobile devices (e.g., smartphones, etc.) or other computing device, and/or virtual machines or cloud-based computing solutions, any or all of which may execute any combination of the software components described herein. The server 500 may, in some examples, correspond to any of the computing systems or devices described above, such as the software integration system 102, the verified application 104B, the developer environment(s) 108, an operator device, and/or any other computing devices, systems, or components executing the software components described herein. It will be appreciated that in various examples described herein, a server 500 might not include all of the components shown in FIG. 5, may include additional components that are not explicitly shown in FIG. 5, and/or may utilize a different architecture from that shown in FIG. 5.

The server 500 includes a baseboard 502, or “motherboard,” which may be a printed circuit board to which a multitude of components or devices are connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the server 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the server 500. The chipset 506 can further provide an interface to a computer-readable storage medium such as a ROM 510 or non-volatile RAM (“NVRAM”) for storing basic routines that help to startup the server 500 and to transfer information between the various components and devices. The ROM 510 or NVRAM can also store other software components necessary for the operation of the server 500 in accordance with the configurations described herein.

The server 500 can operate in a networked environment using logical connections to remote computing devices and computer systems through a network, such as the network 518, which may be similar or identical to any of the communication networks discussed above. The chipset 506 also may include functionality for providing network connectivity through a Network Interface Controller (NIC) 512, such as a gigabit Ethernet adapter. The NIC 512 is capable of connecting the server 500 to other computing devices (e.g., operator devices, external software development environments, test systems, cloud-based deployment systems, etc.) over the network 518. It should be appreciated that multiple NICs 512 can be present in the server 500, connecting the computer to other types of networks and remote computer systems. In some instances, the NICs 512 may include at least on ingress port and/or at least one egress port.

The server 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device.

The server 500 can include one or more storage device(s) 520, which may be connected to and/or integrated within the server 500, that provide non-volatile storage for the server 500. The storage device(s) 520 can store an operating system 522, source code 524 (e.g., in a version control system), and/or applications 526, which may include the development application 104A, the verified application 104B, as described with reference to FIG. 1. The storage device(s) 520 may also store any or all of the systems and/or components described herein e.g., the regression test component 112. The storage device(s) 520 can be connected to the server 500 through a storage controller 514 connected to the chipset 506. The storage device(s) 520 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server 500 can store data on the storage device(s) 520 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 520 are characterized as primary or secondary storage, and the like.

For example, the server 500 can store information to the storage device(s) 520 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server 500 can further read information from the storage device(s) 520 by detecting the physical states or characteristics of one or more particular locations within the physical storage units.

In addition to the storage device(s) 520 described above, the server 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the server 500. In some examples, the various operations performed by the computing systems described herein (e.g., software integration system 102, regression test component 112, etc.), as well as the development and production versions of the application 104A, 104B may be implemented within a datacenter including one or more servers or devices similar to server 500. For instance, some or all of the operations described herein may be performed by one or more server 500 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 520 can store an operating system 522 utilized to control the operation of the server 500. In some examples, the operating system 522 comprises a LINUX operating system. In other examples, the operating system 522 comprises a WINDOWS® SERVER operating system from MICROSOFT Corporation of Redmond, Washington. In further examples, the operating system 522 can comprise a UNIX operating system or one of its variants. It should be appreciated that other operating systems can also be utilized. The storage device(s) 520 can store other system or application programs and data utilized by the server 500.

In various examples, the storage device(s) 520 or other computer-readable storage media is encoded with computer-executable instructions which, when loaded into the server 500, transform the computer from a general-purpose computing system into a special-purpose computer capable of implementing various techniques described herein. These computer-executable instructions transform the server 500 by specifying how the CPUs 504 transition between states, as described above. In some examples, the server 500 may have access to computer-readable storage media storing computer-executable instructions which, when executed by the server 500, perform the various techniques described herein. The server 500 can also include computer-readable storage media having instructions stored thereupon for performing any of the other computer-implemented operations described herein.

As illustrated in FIG. 5, the server 500 may communicate with external systems, such as external services providers, via the network 518. In examples, the external systems may include the external system(s) 110 that provide software services required by the applications 104A, 104B for performing their functions. As discussed, the communication between the server 500 and the external systems over the network 518 may be via structured input and output files (e.g., in JSON format), and the server 500 may not have direct access to databases or source code storage of such external system(s).

As illustrated by the above examples, the techniques described herein provide various technical advantages that improve continuous integration (CI) systems by implementing regression testing to verify the functionality of source code modifications. The regression testing techniques described herein provide solutions for software environments that communicate with external system(s) outside the enterprise, and the inputs and/or outputs of the application are structured files which may contain hierarchical data. In addition, all fields of the output files may not behave similarly with respect to determining differences between two files.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A software testing system, comprising:
a processor; and
memory storing computer-executable instructions that, when executed by the processor, cause the system to perform operations comprising:
receiving first input data including entries in a graphical user interface (GUI);
providing, to a first software application, at least a portion of the first input data;
receiving, from the first software application and based on the first input data, first output data characterized by a structured hierarchy indicating data fields;
providing, to a second software application, the at least the portion of the first input data;
receiving, from the second software application and based on the at least the portion of the first input data, second output data characterized by the structured hierarchy;
removing, from the first output data and the second output data, data values corresponding to at least a portion of the data fields of the structured hierarchy, wherein removing the data values results in filtered first output data and filtered second output data;
determining a difference between the filtered first output data and the filtered second output data;
determining, based on the difference, one or more changes in source code between the first software application and the second software application; and
providing, to an electronic device, a notification indicating the difference and the one or more changes.

2. The software testing system of claim 1, wherein the first software application corresponds to a development version of a policy management system, and the second software application corresponds to a production version of the policy management system.

3. The software testing system of claim 2, wherein the second software application determines the second output data based at least in part on data received from an external system.

4. The software testing system of claim 1, wherein determining the difference further comprises:
determining that a first data field in the first output data is of a first data type; and
determining that the first data field in the second output data is of a second data type, different from the first data type,
wherein the difference is determined based on the second data type being different from the first data type.

5. The software testing system of claim 1, the operations further comprising:
determining that a first data field in the first output data comprises a first array with multiple elements arranged in a first order;
determining that the first data field in the second output data comprises a second array with the multiple elements arranged in a second order, different from the first order; and
based on determining that the second output data comprises the multiple elements and the second order is different from the first order, further removing the multiple elements from the first array and the second array in the filtered first output data and the filtered second output data.

6. The software testing system of claim 1, the operations further comprising:
determining respective likelihoods corresponding to the one or more changes, the likelihoods indicating a certainty level that a respective change caused the difference; and
determining a subset of the one or more changes that correspond to likelihoods greater than a threshold,
wherein the notification presents the subset of the one or more changes and excludes a remainder of the one or more changes.

7. The software testing system of claim 6, wherein the notification presents the subset of the one or more changes in decreasing order of respective likelihoods.

8. The software testing system of claim 6, wherein the likelihoods are determined based on inputting at least the respective change and the difference to a trained machine-learned model.

9. The software testing system of claim 1, wherein:
the notification further includes a textual description of the one or more changes or the difference, and
the textual description is automatically generated by a large language model (LLM) trained on a training set of code changes and resulting differences.

10. The software testing system of claim 1, further comprising:
receiving, from the electronic device, a verification that the difference is as intended; and
based on receiving the verification, determining that the first software application passes the software testing.

11. The software testing system of claim 1, further comprising:
receiving, from the electronic device, an indication that the difference is unintended or incorrect; and
based on receiving the indication, determining that the first software application fails the software testing.

12. A computer-implemented method, comprising:
receiving a first input data indicating inputs to a software application;
providing, to a development version of the software application, the first input data;
receiving, from the development version of the software application and based on the first input data, a first output data characterized by a structure comprising named data fields and corresponding data values;
providing, to a production version of the software application, the first input data;
receiving, from the production version of the software application and based on the first input data, a second output data characterized by the structure;
removing, from the first output data and the second output data, data values corresponding to at least a portion of the named data fields of the structure, wherein removing the data values results in filtered first output data and filtered second output data;
determining a difference in the named data fields or the corresponding data values between the filtered first output data and the filtered second output data;
determining, based on the difference, one or more changes in source code between the development version of the software application and the production version of the software application; and
providing, to an electronic device, a notification indicating the difference and the one or more changes.

13. The computer-implemented method of claim 12, wherein determining the one or more changes is based at least in part on a timestamp associated with a check-in of respective change to a source code repository.

14. The computer-implemented method of claim 12, further comprising:
determining respective likelihoods corresponding to the one or more changes, the likelihoods indicating a certainty level that a respective change caused the difference;
determining a subset of the one or more changes that correspond to likelihoods greater than a threshold,
wherein the notification presents the subset of the one or more changes and excludes a remainder of the one or more changes.

15. The computer-implemented method of claim 12, further comprising:
determining that a first named data field in the first output data comprises a first group of data with multiple elements arranged in a first order;
determining that the first named data field in the second output data comprises a second group of data the multiple elements arranged in a second order, different from the first order; and
based on determining that the second output data comprises the multiple elements and the second order is different from the first order, further removing the multiple elements from the first group of data and the second group of data in the filtered first output data and the filtered second output data.

16. The computer-implemented method of claim 12, further comprising:
receiving, from the electronic device, a verification that the difference is as intended;
based on receiving the verification, determining that the production version of the software application can be replaced by the development version of the software application.

17. The computer-implemented method of claim 12, further comprising:
generating, based on an output of a large language model (LLM), a textual description of the one or more changes or the difference,
wherein the notification further includes the textual description.

18. A non-transitory computer-readable medium storing instructions which, when executed by a processor causes the processor to:
receive a first input data indicating test inputs to a software application;
provide, to a first version of the software application, the first input data;
receive, from the first version of the software application and based on the first input data, a first output data characterized by a structure comprising data fields and corresponding data values;
provide, to a second version of the software application, the first input data;
receive, from the second version of the software application and based on the first input data, a second output data characterized by the structure;
remove, from the first output data and the second output data, data values corresponding to at least a portion of the data fields of the structure, wherein removing the data values results in filtered first output data and filtered second output data;
determine a difference in the data fields or the corresponding data value between the filtered first output data and the filtered second output data;
determine, based on the difference, one or more changes in source code between the first version of the software application and the second version of the software application; and
provide, to an electronic device, a notification indicating the difference and the one or more changes.

19. The non-transitory computer-readable medium of claim 18, wherein the first version and the second version determine the first output data and the second output data based at least in part on data received from an external system.

20. The non-transitory computer-readable medium of claim 18, the instructions further causing the processor to:
receive, from the electronic device, a verification that the difference is as intended; and
based on receiving the verification, determine that the first version of the software application passes a regression test with respect to the second version of the software application.
